(19) United States
(12) Patent Application Publication
(10) Pub. No.: US 2004/0134174 A1
(43) Pub. Date: Jul. 15, 2004

(54) Tubular filtering conduit for radial flow reactor

(76) Inventor: Naderi Adhel-Hossein, Poitiers (FR)

Correspondence Address: SUGHRUE MION, PLLC, 2100 PENNSYLVANIA AVENUE, N.W., SUITE 800, WASHINGTON, DC, 20037, US

(21) Appl. No.: 10/472,945

(22) PCT Filed: Mar. 6, 2002
(86) PCT No.: PCT/FR02/00808

(30) Foreign Application Priority Data
Mar. 28, 2001 (FR) 01/04150

(51) Int. Cl. B01D 46/00

(52) U.S. Cl. 55/525

(57) ABSTRACT

A tubular filter duct for a radial flow reactor has a crescent-shaped cross-section. It comprises a convex front wall forming the belly (VE) of the duct, a convex back wall forming the back (DO), and two convex side walls forming the flanks (FL) of the duct. The walls are constituted by a mesh made up of rectilinear wires (FR) and support rods (FC) that are looped by being curved so that the walls are perforated around the entire periphery of the duct and are elastically deformable in a radial direction.

The invention relates to a tubular filter duct for a radial flow reactor, the duct having a crescent-shaped cross-section and comprising a front first curved wall extending in an axial direction of the duct and defining a first radius of curvature for the periphery of said cross-section, a back second curved wall opposite the front wall and defining a second radius of curvature for the periphery of said cross-section, the second radius of curvature being greater than the first radius of curvature, and two side third curved walls uniting said front and back walls and each defining a third radius of curvature for the periphery of said cross-section, which third radius of curvature is smaller than the first radius of curvature.

Such a duct is already known from patent documents U.S. Pat. No. 5,366,704 and U.S. Pat. No. 5,015,383 which describe radial flow reactors. Those reactors comprise a bed of solid particles in the form of a torus and they are designed so that a fluid or a gas introduced into the reactor passes through said bed of particles in a radial direction prior to leaving the reactor. Such reactors are commonly used for petrochemical processes in which the fluid flow is subjected to various chemical reactions on passing through the bed of particles which acts as a catalyst. The toroidal bed is externally defined by a substantially cylindrical jacket, and is internally defined by a cylindrical central duct extending along the main axis of the jacket. The fluid or gas for filtering is introduced into the jacket via a set of tubular filter ducts extending parallel to the main axis of the jacket and distributed over the transverse periphery of the jacket, each having its back wall pressed against the cylindrical surface of the jacket. In the literature, such tubular filter ducts having a crescent-shaped cross-section are referred to as “scallops”.

In document U.S. Pat. No. 5,366,704, the tubular filter duct is made from perforated sheet metal which is shaped by bending and by folding. In particular, the side walls of the duct are folded, which means that in order to avoid weakening them they must not be provided with openings for passing the fluid or gas for filtering. As a result, there are dead zones between pairs of adjacent ducts in the cylindrical jacket of the reactor, where no fluid or gas flows through and in which solid substrates accumulate which tend to accelerate aging of the filter duct, and thus of the reactor, because of the pressure stresses they exert over time on the walls of the ducts. In particular, the solid particles which accumulate in the dead zones of the reactor stick together when the reactor cools down and they become extremely hard. More generally, the thermal cycles to which the reactor is subjected give rise to differential expansion which, combined with the presence of solid particles, leads to high levels of stress being generated on the walls of the filter ducts.

In document U.S. Pat. No. 5,015,383, each filter duct is made of a cylinder having a meshed surface which is deformed by being flattened in a matrix so as to give it a crescent-shaped cross-section, and this reduces the strength of the duct by creating stress concentration zones in the side walls of the filter duct where the radius of curvature is very small.

The object of the invention is to remedy those drawbacks by proposing a tubular filter duct for a radial flow reactor which presents better strength over time, and of structure that makes it possible to reduce dead or inactive spaces in reactors.

To this end, the invention provides a tubular filter duct for a radial flow reactor, the duct having a crescent-shaped cross-section and comprising a front first curved wall extending in an axial direction of the duct and defining a first radius of curvature for the periphery of said cross-section, a back second curved wall opposite the front wall and defining a second radius of curvature for the periphery of said cross-section, the second radius of curvature being greater than the first radius of curvature, and two side third curved walls uniting said front and back walls and each defining a third radius of curvature for the periphery of said cross-section, which third radius of curvature is smaller than the first radius of curvature, the duct being characterized in that said first, second, and third walls are formed by a mesh made up of parallel rectilinear wires extending in said axial direction and distributed around the entire periphery of said cross-section and support rods extending perpendicularly to said wires around the periphery of said cross-section to co-operate with the wires to form longitudinal openings of dimensions that are substantially constant in said walls of the duct, each support rod (FC) being looped by being curved so as to form said radii of curvature.

Thus, the tubular filter duct of the invention is perforated so as to act as a filter over its entire surface because of the mesh made by the wires and the rods, thus avoiding creating dead zones in the reactor, however the bending of the rods to make the closed loops thereof confers elasticity in deformation to the walls of the duct which enables the duct to withstand better over time the pressure stresses exerted by the catalyst in the reactor and by the deformations of the reactor jacket during changes in its temperature.

In a preferred embodiment of the filter duct of the invention, the third radius of curvature of said cross-section is greater than one-sixth the first radius of curvature.

In another preferred embodiment of the filter duct of the invention, the support rods are disposed inside the duct and are welded to the wires. The mechanical characteristics of the rods and the number of rods in a duct need to be appropriate for the pressure stresses to which the duct is subjected in the radial flow reactor.

In yet another particular embodiment of the filter duct of the invention, said wires are regularly spaced around the periphery of said cross-section at a spacing that is substantially constant so that the density of liquid or gaseous flow is uniform over the entire surface of the duct.

The invention also provides a method of manufacturing a tubular filter duct as defined above, the method being characterized in that it consists in forming a cylinder made of support rods extending parallel to one another along the axis of the cylinder and disposed around the cross-section of the cylinder, and wires extending parallel to one another along the periphery of the cross-section of the cylinder; then splitting said cylinder longitudinally between two consecutive rods in the periphery of the cross-section of the cylinder in order to obtain a plate having a perforated surface formed by the mesh of support rods and wires; then curving the plate in a direction perpendicular to the wires in such a manner as to loop said support rods so as to form the tubular duct of crescent-shaped cross-section; and then welding the two ends of each support rod to a connecting strip.

In a variant of the method of manufacturing the duct, while making the cylinder, said wires are welded to the support rods while being spaced apart from one another at spacing that varies in such a manner that the spacing between said wires remains substantially constant around the entire periphery of the cross-section of the duct once the plate has been curved.

An embodiment of the invention is described in greater detail and is shown in the accompanying drawings.

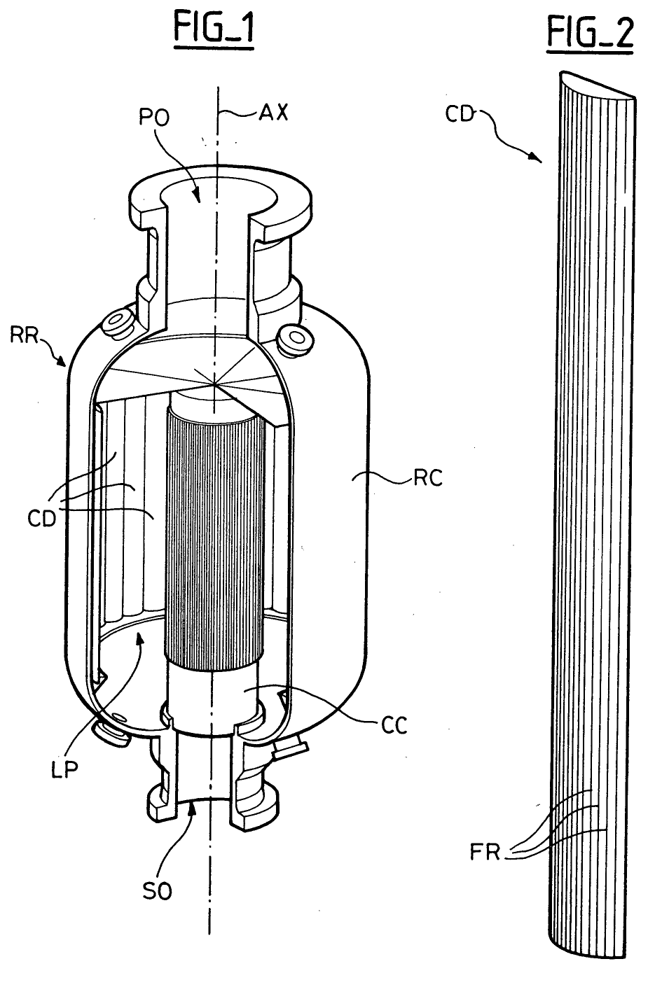

FIG. 1 is an overall view in partial section of a radial flow reactor.

FIG. 2 is an overall view of a tubular filter duct of the invention.

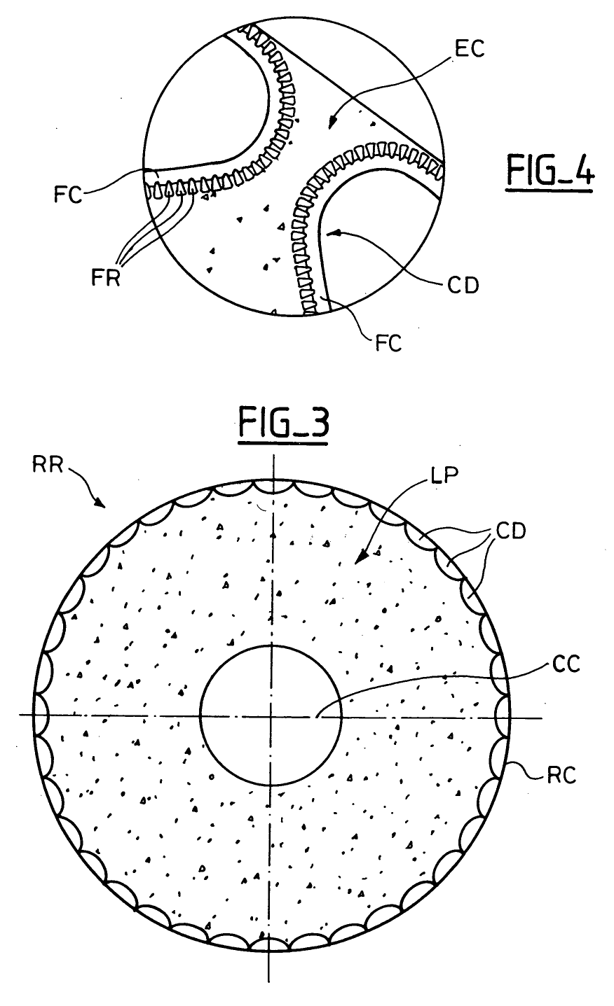

FIG. 3 is a cross-section view of a radial flow reactor.

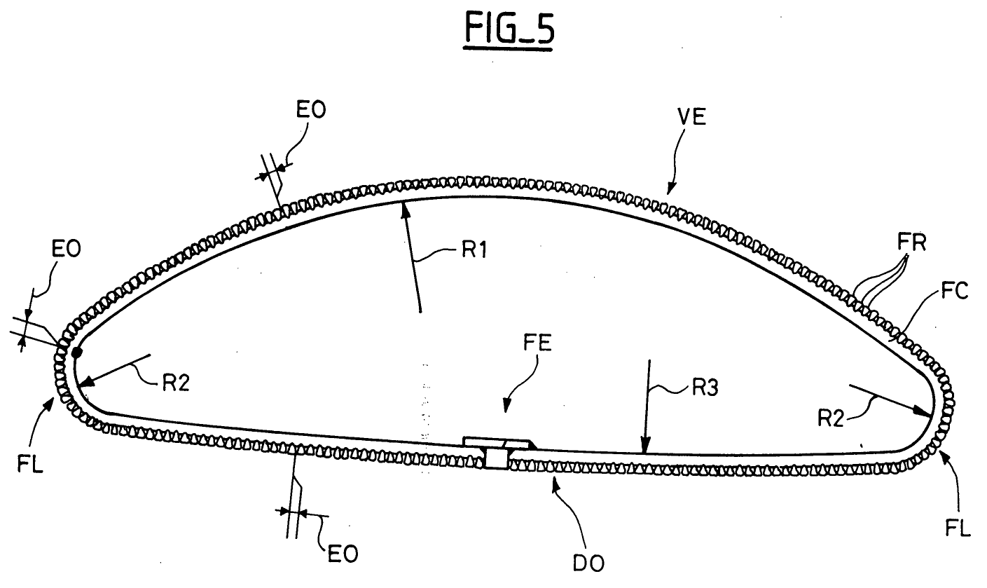

FIG. 4 is a section view showing the gap between two consecutive tubular filter ducts in a radial flow reactor.

FIG. 5 is a cross-section view of a tubular filter duct of the invention.

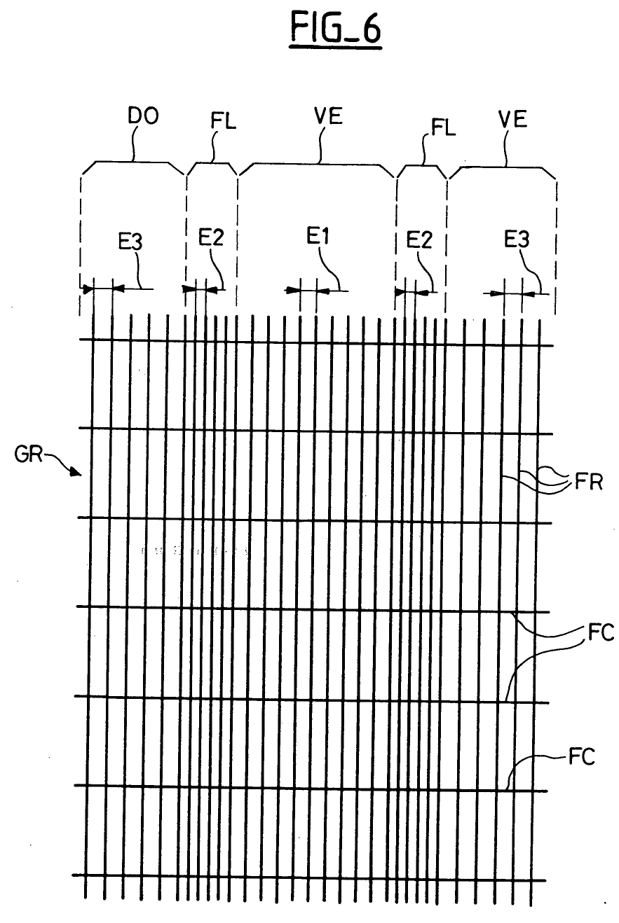

FIG. 6 is a highly diagrammatic view of the mesh formed by the wires and the rods constituting a kind of grid from which the filter duct of the invention is made.

As shown in FIG. 1, a radial flow reactor RR is outwardly cylindrical in shape, forming a cylindrical tank RC extending about an axis of symmetry AX. In its top portion, the tank has a first orifice PO, and in its bottom portion it has a second orifice SO. The orifices PO and SO are intended respectively to constitute an inlet and an outlet for a fluid flowing through the reactor.

Inside the cylindrical tank there are disposed side by side a plurality of internal tubular filter ducts CD that extend longitudinally. These ducts are held by the tank RC and pressed against the inside face of the tank, parallel to the axis AX, so as to form a substantially cylindrical jacket that is visible in cross-section in FIG. 3. In this case, the ducts CD are in direct communication with the first orifice PO via their top ends for receiving a flow of fluid. The fluid diffuses through the perforated walls of the ducts as can be seen in FIG. 2 so as to pass through a bed of solid particles LP while converging radially towards the center of the reactor. The fluid is then collected by a central cylinder CC extending along the axis AX and also having a perforated wall. In this case, the central cylinder CC is in communication with the second orifice SO of the reactor via its bottom end. Thus, the fluid introduced via the first orifice PO passes along the ducts CD leaving them radially to pass through the bed of particles and is then collected by the central cylinder CC so as to leave via the second orifice SO. Such a reactor can also operate in the opposite direction, i.e. it can receive fluid via the second orifice SO and deliver fluid via the first orifice PO.

The tubular filter duct CD of the invention as shown in cross-section in FIG. 5 comprises a curved front wall forming the belly VE of the duct that is to face the main axis AX of the reactor, a curved back wall forming the back DO of the duct for placing against the inside wall of the tank RC, the belly and the back being interconnected by two curved side walls forming the two flanks FL of the duct, with the entire shape seen in section having a cross-section that is crescent-shaped as can be seen in FIG. 5. More particularly, the periphery of the cross-section of the duct is constituted by four circular arcs each having a respective radius of curvature, the belly defining a first radius of curvature R1 complying with the requirements of the filtering process, each of the flanks defining a second radius of curvature R2 that is smaller than. R1, and the back defining a third radius of curvature R3 which is the radius of the cylindrical tank RC and which is greater than the radius R1. In general, the radius of curvature R2 defined by the flanks FL is very small because it is the result, for example, of a folding operation performed by flattening as in U.S. Pat. No. 5,015,383, thereby generating a zone in which mechanical stresses are concentrated, thereby reducing the strength of the duct. In the duct of the invention, the radius of curvature R2 of the flanks is selected to be sufficiently large and it is obtained by curving such that it does not weaken the duct, but on the contrary it constitutes a resilient zone that acts as a spring. By selecting a radius of curvature R2 that is sufficiently large, it is thus possible to absorb better the stresses applied by the bed of solid particles LP to the belly of the duct during the successive thermal cycles to which the reactor is subjected. In such a context, it has been found that when R2 is greater than one-sixth of R1, the lifetime of the duct is considerably increased.

The filter duct of the invention is made from parallel wires welded to support rods in such a manner as to make a wall that is perforated over the entire periphery of the duct so as to reduce dead spaces in the reactor. More particularly, the duct is made up of rectilinear wires FR placed parallel to one another along the longitudinal axis of the duct, as can be seen in FIG. 2. These wires FR are distributed over the entire periphery of the crescent-shaped cross-section of the duct and they are welded to support rods FC which extend perpendicularly to the wires FR along the periphery of the cross-section of the duct so as to co-operate with the wires to form longitudinal filter openings of dimensions that are substantially constant in the belly, in the back, and in the flanks of the duct. These support rods FC are looped by curving as mentioned above so as to form the radii of curvature R1, R2, and R3 of the cross-section of the duct. They thus form loops in planes perpendicular to the wires FR. The two ends of each support rod FC are fixed together by being welded to a strip FE which extends along the entire length of the duct, and which enables the duct to have a closed profile. In section, the wires FR may advantageously be trapezium shaped, with the short side of the trapezium facing in the direction of flow through the reactor.

Thus, the gap EC situated between two consecutive ducts in the reactor, as shown in FIG. 4, is no longer a dead space since the flanks FL are themselves perforated, thus enabling fluid to diffuse into said gap and prevent clogging occurring by the solid substrate accumulating therein, thereby contributing to increasing the lifetime of the reactor.

It is the rectilinear wires FR which allow the fluid to pass while preventing particles to pass through the wall of the duct. Thus, the rectilinear wires act as a filter, while the looped rods act as supports for the rectilinear wires and are disposed inside the duct. The rectilinear wires FR of the invention are regularly spaced apart around the periphery of the cross-section of the duct with a spacing E0 that is substantially constant, in spite of the different radii of curvature of said section, thereby contributing to ensuring that the density of the flow passing through the duct is uniform over its entire wall so as to further reduce the formation of solidified substrate in all zones situated around the duct.

In order to make such a duct, a cylinder is formed initially constituted by rectilinear support rods FC extending parallel to one another along the axis of the cylinder and disposed around the cross-section of the cylinder, together with wires FR rolled parallel to one another about the rods FC along the periphery of the cross-section of the cylinder. Then the cylinder is split longitudinally by sawing between two consecutive rods FC in the periphery of the cross-section of the cylinder so as to obtain a plate or grid GR having a perforated surface formed by the mesh of rods supporting the wires. The plate GR is then curved in a direction perpendicular to the wires FR so as to loop the support rods FC and form the tubular duct of crescent-shaped cross-section. Finally, the two ends of each support rod FC are welded to the connection strip FE.

FIG. 6 is a diagram showing the disposition of the wires FR and of the rods FC forming the plate or grid GR. While constructing the cylinder, variations in the radii of curvature are taken into account by welding the wires FR to the rods FC with varying spacing between the rods FR so that the spacing between the wires FR once the plate GR has been curved remains substantially constant around the entire periphery of the cross-section of the duct. As shown in FIG. 6, in the zone of the grid GR corresponding to the belly of the duct, the wires FR are spaced apart at a first spacing E1. In the zones of the grid GR corresponding to the flanks of the duct, the wires FR are spaced apart at a second spacing E2. In the zone of the grid corresponding to the back DO of the duct, the wires FR are spaced apart at a third spacing E3. As can be seen in FIG. 6, the spacings E1, E2, and E3 between the wires are smaller when the wires occupy a portion of the wall of the duct that defines a smaller radius of curvature. Thus, once the grid has been curved perpendicularly to the wires FR, the resultant spacing E0 between two consecutive rectilinear wires is the same around the entire periphery of the duct. In practice, the values of the spacings E1, E2, and E3 may be determined by calculation, as a function of a predefined target value E0.

Each tubular filter duct may be fitted with a filtering end wall, with fixing means at both ends, and with means for making a connection with another filter duct that is adjacent thereto in the reactor.

1/ A tubular filter duct for a radial flow reactor, the duct having a crescent-shaped cross-section and comprising a front first curved wall (VE) extending in an axial direction of the duct and defining a first radius of curvature (R1) for the periphery of said cross-section, a back second curved wall (DO) opposite the front wall and defining a second radius of curvature (R3) for the periphery of said cross-section, the second radius of curvature being greater than the first radius of curvature, and two side third curved walls (FL) uniting said front and back walls and each defining a third radius of curvature (R2) for the periphery of said cross-section, which third radius of curvature is smaller than the first radius of curvature, the duct being characterized in that said first, second, and third walls (VE, DO, FL) are formed by a mesh made up of parallel rectilinear wires (FR) extending in said axial direction and distributed around the entire periphery of said cross-section and support rods (FC) extending perpendicularly to said wires around the periphery of said cross-section to co-operate with the wires to form longitudinal openings of dimensions that are substantially constant in said walls (VE, DO, FL) of the duct, each support rod (FC) being looped by being curved so as to form said radii of curvature.

2/ The filter duct according to claim 1, in which the third radius of curvature (R2) of said cross-section is greater than one-sixth the first radius of curvature (R1).

3/ A filter duct according to claim 1 or claim 2, in which the support rods (FC) are disposed inside the duct and are welded to the wires (FR).

4/ A filter duct according any one of claims 1 to 3, in which said wires (FR) are regularly spaced around the periphery of said cross-section at a spacing that is substantially constant.

5/ A method of manufacturing a filter duct according to any one of claims 1 to 4, characterized in that it consists in forming a cylinder made of support rods (FC) extending parallel to one another along the axis of the cylinder and disposed around the cross-section of the cylinder, and wires (FR) extending parallel to one another along the periphery of the cross-section of the cylinder; then splitting said cylinder longitudinally between two consecutive rods (FC) in the periphery of the cross-section of the cylinder in order to obtain a plate having a perforated surface formed by the mesh of support rods and wires; then curving the plate in a direction perpendicular to the wires (FR) in such a manner as to loop said support rods (FC) so as to form the tubular duct of crescent-shaped cross-section; and then welding the two ends of each support rod to a connecting strip.

6/ A method of manufacture according to claim 5, in which, while making the cylinder, said wires (FR) are welded to the support rods (FC) while being spaced apart from one another at spacing that varies in such a manner that the spacing between said wires (FR) remains substantially constant around the entire periphery of the cross-section of the duct once the plate has been curved.
